(19) United States
(12) Patent Application Publication
(10) Pub. No.: US 2023/0169626 A1
(43) Pub. Date: Jun. 1, 2023

(54) NEURAL NETWORK SYSTEM AND METHOD FOR RESTORING IMAGES USING TRANSFORMER AND GENERATIVE ADVERSARIAL NETWORK

(71) Applicant: KWAI INC., Palo Alto, CA (US)

(72) Inventors: Ahmed Cheikh SIDIYA, Palo Alto, CA (US); Xuan XU, Palo Alto, CA (US); Ning XU, Irvine, CA (US)

(73) Assignee: KWAI INC., Palo Alto, CA (US)

(21) Appl. No.: 17/539,168

(22) Filed: Nov. 30, 2021

(51) Int. Cl. G06T 3/40; G06T 9/00; G06T 5/00; G06K 9/62; G06V 10/77; G06N 3/04

(52) U.S. Cl. CPC G06T 3/4053; G06T 9/002; G06T 5/001; G06K 9/6232; G06V 10/7715; G06K 9/6256; G06T 3/4046; G06N 3/0454; G06T 2207/20081; G06T 2207/20084

(57) ABSTRACT

A neural network system for restoring images, a method and a non-transitory computer-readable storage medium thereof are provided. The neural network system includes an encoder and a generative adversarial network (GAN) prior network. The encoder includes a plurality of encoder blocks, where each encoder block includes at least one transformer block and one convolution layer, where the encoder receives an input image and generates a plurality of encoder features and a plurality of latent vectors. Additionally, the GAN prior network includes a plurality of pre-trained generative prior layers, where the GAN prior network receives the plurality of encoder features and the plurality of latent vectors from the encoder and generates an output image with super-resolution.

### FIELD

The present application generally relates to restoring images, and in particular but not limited to, restoring images using neural networks.

### BACKGROUND

With the advancements in deep learning, new architectures based on convolution neural networks (CNNs) are dominating the state of art results in the field of image restoration. Building blocks of CNNs are convolution layers, each of which consists of multiple learnable filters each convolved with its input. Filters belonging to early layers are responsible for recognizing global information, e.g., edges, and deeper layers can detect more complicated pattern, e.g., shape. The receptive field of a convolution layer indicates the size of the window around the certain position in the feature input used to predict its value for the next layer. A popular receptive field is a window of size 3×3, increasing the receptive field to encompass the whole feature is not feasible due to the exponential increase in computational cost.

Image restoration approaches are usually based on a supervised learning paradigm where existence of important number of paired datasets including corrupted and uncorrupted images is necessary for convergence of the model parameters. Traditional Image restoration methods usually apply artificial degradation to a clean and high-quality image to get a corresponding corrupted one. Bicubic down-sampling is used extensively in the case of single image super-resolution. However, these traditional methods exhibit grave limitations when tested on the wild corrupted images.

### SUMMARY

The present disclosure describes examples of techniques relating to restoring images using transformer and generative adversarial network (GAN).

According to a first aspect of the present disclosure, a neural network system implemented by one or more computers for restoring an image is provided. The neural network system includes an encoder and a GAN prior network. Furthermore, the encoder includes a plurality of encoder blocks, where each encoder block includes at least one transformer block and one CNN layer, and the encoder receives an input image and generates a plurality of encoder features and a plurality of latent vectors. Moreover, the GAN prior network includes a plurality of pre-trained generative prior layers, where the GAN prior network receives the plurality of encoder features and the plurality of latent vectors from the encoder and generates an output image with super-resolution.

According to a second aspect of the present disclosure, a method is provided for restoring an image using a neural network system including an encoder and a GAN prior network implemented by one or more computers. The method includes that: the encoder receives an input image, where the encoder includes a plurality of encoder blocks, and each encoder block includes at least one transformer block and one CNN layer; the encoder generates a plurality of encoder features and a plurality of latent vectors; and the GAN prior network generates an output image with super-resolution based on the plurality of encoder features and the plurality of latent vectors, where the GAN prior network includes a plurality of pre-trained generative prior layers.

According to a third aspect of the present disclosure, a non-transitory computer readable storage medium including instructions stored therein is provided. Upon execution of the instructions by one or more processors, the instructions cause the one or more processors to perform acts including: receiving, by an encoder in a neural network system, an input image, where the encoder includes a plurality of encoder blocks, and each encoder block includes at least one transformer block and one CNN layer; generating, by the encoder, a plurality of encoder features and a plurality of latent vectors; and generating, by a GAN prior network in the neural network system, an output image with super-resolution based on the plurality of encoder features and the plurality of latent vectors, where the GAN prior network includes a plurality of pre-trained generative prior layers.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1 is a block diagram illustrating a neural network system including an encoder with transformer blocks and a GAN prior network in accordance with an example of the present disclosure.

FIG. 2 is a block diagram illustrating a neural network system including an encoder with transformer blocks, a GAN prior network, and a decoder in accordance with another example of the present disclosure.

FIG. 3 is a block diagram illustrating a transformer block in the neural network system shown in FIG. 1, FIG. 2 or FIG. 5 in accordance with another example of the present disclosure.

FIG. 4 is a block diagram illustrating a self-attention layer in the transformer block shown in FIG. 3 in accordance with another example of the present disclosure.

FIG. 5 is a block diagram illustrating how to merge inputs of a generative prior layer in a GAN prior network in accordance with another example of the present disclosure.

FIG. 6 illustrates comparison among output images obtained through right bicubic up-sampling, PSFRGAN, GFP-GAN and the neural network system in accordance with another example of the present disclosure.

FIG. 7 is a flowchart illustrating a method for restoring an image using a neural network system implemented by one or more computers in accordance with another example of the present disclosure.

FIG. 8 is a flowchart illustrating a method for restoring an image using a neural network system implemented by one or more computers in accordance with another example of the present disclosure.

FIG. 9 illustrates an apparatus for restoring an image using a neural network system implemented by one or more computers in accordance with another example of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g. devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may include steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

Non-local convolution and self-attention calculate the value at a position as the weighted sum of the features at all position. An attention map is learned from the input and used as the weights. With both the non-local convolution and the self-attention, the receptive field is increased to encompass the whole feature size. However, such layers can only be used with input of low spatial dimension due to costly matrix multiplication needed for attention map calculation. To use the non-local information for input of high spatial dimension, vision transformer (ViT) is proposed. ViT divides the input into patches of small size and processes these patches instead of processing a single position in the feature. Convolution transformer (CvT) extends ViT by using convolution layers instead of fully connected layers to decrease the number of parameters in the network.

The present disclosure provides a neural network system and a method for restoring images using transformer and GAN. The method adds non-local information to the neural network system by including transformer blocks that can be used on input image of high spatial dimension, where the input image may have a resolution of 64×64, 96×96, 128×128, etc.

Learning image prior models is essential for image restoration. Image priors may be used to capture certain statistics of images, e.g. natural images so as to reconstruct corrupted images. A well-trained GAN contains useful prior information for the task of image restoration. For example, the use of the state-of-the-art generative model for face synthesis will help a network learn important facial details to reconstruct more faithfully low-quality faces. The present disclosure incorporates generative priors to the neural network system by using weights of a trained GAN, such as style based GAN (StyleGAN), as part of the overall architecture.

Furthermore, the present disclosure incorporates both the non-local information and the generative prior, showing results when used for the task of face image super-resolution.

Transformer neural networks, i.e., transformers, are popular sequence modeling architectures, which have been widely used in many tasks such as machine translation, language modeling, and image generation and objective detection. A transformer neural network can take an input in the form of a sequence of vectors, and converts it into a vector called an encoding, and then decodes it back into another sequence. Transformers can outperform the previously de facto sequence modeling choice, i.e., recurrent neural networks (RNNs), and CNN based models.

CvT uses transformer blocks for image recognition. The building block of CvT is transformer block. A transformer block may consist of a convolution layer followed by dividing the input into multiple patches. After that, a transformer block is used, composed of projection layer, multi-head attention and fully connected layer. CvT is used for image recognition but hasn't been tested on image restoration tasks. In the present disclosure, the idea of transformer is incorporated in the neural network system for restoring images and used for face image super-resolution.

A CNN that incorporates a pre-trained network of StyleGAN may achieve great results of image super-resolution. The CNN may be composed of encoder and decoder networks separated by trained weights of a generative model. Both encoder and decoder are built with successive convolution layers. In addition, the decoder may contain a pixel shuffle layers to up-sample input features.

The prior information is combined by adding skip connection or concatenation operation between the encoder and the pretrained StyleGAN network as well as between the GAN prior network and the decoder. The network is trained end to end with perceptual loss, mean square loss and cross entropy loss. It is trained for 200 thousand iterations. Such CNN may lack ability to utilize non-local information for face reconstruction.

The present disclosure uses generative prior network as well as transformer blocks to build the network architecture. The transformer blocks enable the neural network system to learn the long-range dependencies in the feature input. In natural images, similar patches may have different or opposite regions of the 2D image space. In the case of the human face, the property of symmetry implies that regions on different parts share major similarities. For example, ears and eyes of one person have in general similar shape and color. Classical convolution operation is not able to take advantage of such dependencies. By including the transformer block, every pixel in the feature map is predicted by using a learned weighted average of all pixels in the input features.

In addition, the present disclosure incorporates the generative prior in the neural network system by adding weights of trained StyleGAN as part of the deep learning network.

Therefore, the proposed neural network system in the present disclosure learns long-range dependencies in the input image through the inclusion of the transformer blocks in the encoder. Furthermore, skip connections between the encoder and the prior are composed of other transformer blocks which help to learn the dependencies between encoder features and prior network features. In some examples in accordance with the present disclosure, the encoder features may be a plurality features extracted by a plurality of encoder blocks in the encoder from an input image and the prior network features may be a plurality outputs related to image priors generated by a plurality of generative prior layers in a GAN prior network.

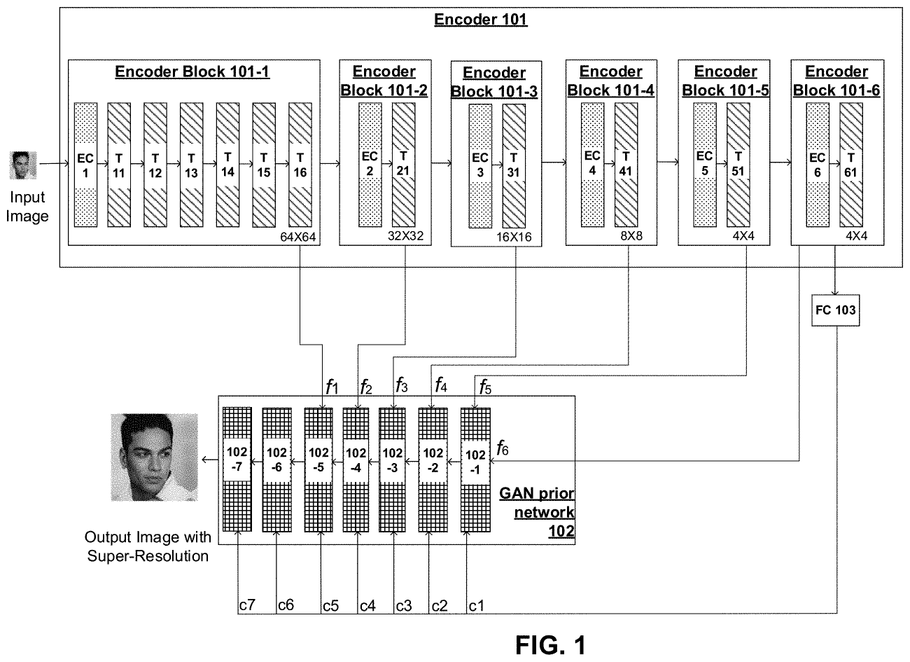

FIG. 1 is a block diagram illustrating a neural network system including an encoder with transformer blocks and a GAN prior network in accordance with an example of the present disclosure. The neural network system may include multiple blocks and layers. Each block may further include a plurality of layers with different operations. Each layer or each block may be implemented by processing circuities in a kernel-based machine learning system. For example, a layer or a block in the neural network system may be implemented by one or more compute unified device architecture (CUDA) kernels that can run directly on GPUs.

The encoder network, i.e., the encoder, is built using successive transformer blocks, each of which may include self-attention layer and residual block. As shown in FIG. 1, the neural network system includes an encoder 101 and a GAN prior network 102. The encoder 101 includes a plurality of encoder blocks. For example, the plurality of encoder blocks may include an encoder block 101-1, an encoder block 101-2, an encoder block 101-3, . . . , and an encoder block 101-6. The encoder block 101-1 includes a convolution layer EC 1 and a plurality of transformer blocks. The plurality of transformer blocks may include transformer blocks T11, T12, T13, T14, T15, and T16, as shown in FIG. 1.

Further, the encoder block 101-2 includes a convolution layer EC 2 and a transformer block T21. The encoder block 101-3 includes a convolution layer EC 3 and a transformer block T31. The encoder block 101-4 includes a convolution layer EC 4 and a transformer block T41. The encoder block 101-5 includes a convolution layer EC 5 and a transformer block T51. The encoder block 101-6 includes a convolution layer EC 6 and a transformer block T61.

The encoder block 101-1 receives an input image having a low-resolution and extracts encoder features f₁ from the input image. The input image may be a face image. The encoder features f₁ are sent to both the GAN prior network 102 and the encoder block 101-2 that subsequently follows the encoder block 101-1. In an example, the encoder features f₁ may have a resolution of 64×64 as shown in FIG. 1. In the encoder block 101-1, the convolution layer EC 1 and the plurality of transformer blocks T11-T16 are stacked to each other, and the convolution layer EC 1 is followed by the plurality of transformer blocks T11-T16. The number of the plurality of transformer blocks in the encoder 101 is not limited to 6.

The encoder block 101-2 receives the encoder features f₁ from the encoder block 101-1 and generates the encoder features f₂. The encoder features f₂ are sent to both the GAN prior network 102 and the encoder block 101-3 that subsequently follows the encoder block 101-2. In an example, the encoder features f₂ may have a resolution of 32×32 as shown in FIG. 1. In the encoder block 101-2, the convolution layer EC 2 is followed by the transformer block T21.

The encoder block 101-3 receives the encoder features f₂ from the encoder block 101-2 and generates the encoder features f₃. The encoder features f₃ are sent to both the GAN prior network 102 and the encoder block 101-4 that subsequently follows the encoder block 101-3. In an example, the encoder features f₃ may have a resolution of 16×16 as shown in FIG. 1. In the encoder block 101-3, the convolution layer EC 3 is followed by the transformer block T31.

The encoder block 101-4 receives the encoder features f₃ from the encoder block 101-3 and generates the encoder features f₄. The encoder features f₄ are sent to both the GAN prior network 102 and the encoder block 101-5 that subsequently follows the encoder block 101-4. In an example, the encoder features f₄ may have a resolution of 8×8 as shown in FIG. 1. In the encoder block 101-4, the convolution layer EC 4 is followed by the transformer block T41.

The encoder block 101-5 receives the encoder features f₄ from the encoder block 101-4 and generates the encoder features f₁. The encoder features f₁ are sent to both the GAN prior network 102 and the encoder block 101-6 that subsequently follows the encoder block 101-5. In an example, the encoder features f₁ may have a resolution of 4×4 as shown in FIG. 1. In the encoder block 101-5, the convolution layer EC 5 is followed by the transformer block T51.

The encoder block 101-6 receives the encoder features f₅ from the encoder block 101-5 and generates the encoder features f₆. The encoder features f₆ are sent to the GAN prior network 102. In an example, the encoder features f₆ may have a resolution of 4×4 as shown in FIG. 1. In the encoder block 101-6, the convolution layer EC 6 is followed by the transformer block T61. In addition, a fully connected layer FC 103 receives the encoder features f₆ and generates latent vectors c1, c2, c3, . . . , c7 which are latent vectors for the GAN prior network 102, as shown in FIG. 1. The latent vectors c1, c2, c3, . . . , and c7 capture a compressed representation of images, providing the GAN prior network 102 with high-level information. The encoder features f₁, f₂, . . . , f₆ that are fed into the GAN prior network further capture the local structures of the input image that has low resolution.

As shown in FIG. 1, the GAN prior network 102 includes a plurality of generative prior layers. The plurality of generative prior layers may include generative prior layers 102-1, 102-2, 102-3, . . . , and 102-7 that are stacked to each other. The number of the plurality of generative prior layers is not limited to 7. FIG. 1 is only for illustrating.

The generative prior layer 102-1 receives inputs including the encoder features f₅ from the encoder block 101-5, the encoder features f₆ from the encoder block 101-6, and the latent vector c1 from the fully connected layer FC 103, and then generates an output feature. The generative prior layer 102-2 receives the output feature from the generative prior layer 102-1. In addition to the output feature of the generative prior layer 102-1, the generative prior layer 102-2 receives the encoder features f₄ from the encoder block 101-4 and the latent vector c2 from the fully connected layer FC 103. After receiving the inputs, the generative prior layer 102-2 generates an output feature and sends the output feature to the generative prior layer 102-3 that subsequently follows the generative prior layer 102-2.

Similarly, the generative prior layer 102-3 receives the output feature from the generative prior layer 102-2. In addition to the output feature of the generative prior layer 102-2, the generative prior layer 102-3 receives the encoder features f₃ from the encoder block 101-3 and the latent vector c3 from the fully connected layer FC 103. After receiving the inputs, the generative prior layer 102-3 generates an output feature and sends the output feature to the generative prior layer 102-4 that subsequently follows the generative prior layer 102-3.

Similarly, the generative prior layer 102-4 receives the output feature from the generative prior layer 102-3. In addition to the output feature of the generative prior layer 102-3, the generative prior layer 102-4 receives the encoder features f₂ from the encoder block 101-2 and the latent vector c4 from the fully connected layer FC 103. After receiving the inputs, the generative prior layer 102-4 generates an output feature and sends the output feature to the generative prior layer 102-5 that subsequently follows the generative prior layer 102-4.

Similarly, the generative prior layer 102-5 receives the output feature from the generative prior layer 102-4. In addition to the output feature of the generative prior layer 102-4, the generative prior layer 102-5 receives the encoder features f₁ from the encoder block 101-1 and the latent vector c5 from the fully connected layer FC 103. After receiving the inputs, the generative prior layer 102-5 generates an output feature and sends the output feature to the generative prior layer 102-6 that subsequently follows the generative prior layer 102-5.

The generative prior layer 102-6 receives the output feature from the generative prior layer 102-5 and the latent vector c6 from the fully connected layer FC 103, and then generates an output feature. The generative prior layer 102-7 that follows the generative prior layer 102-6 receives the output feature from the generative prior layer 102-6 and the latent vector c7 from the fully connected layer FC 103, and then generates an output image with super-resolution. In some examples, the output image is reconstructed from the input image and at least doubles the resolution of the input image.

Each generative prior layer 102-1, 102-2, . . . , or 102-6 in FIG. 1 may include a same structure as a generator in a traditional GAN or StyleGAN. In some examples, each generative prior layer shown in FIG. 1 uses a merge block 500 illustrated in FIG. 5 to merge or combine inputs of the generative prior layer. For example, in the generative prior layer 102-2, its inputs including the encoder features f₄ and the output feature generated by the generative prior layer 102-1 are concatenated using a concatenating layer 501. That is, the encoder feature f₄ is the input 1 of the concatenating layer 501 and the output feature generated by the generative prior layer 102-1 is the input 2 of the concatenating layer 501. The concatenating layer 501 generates a concatenated output based on the input 1 and the input 2 and sends the concatenated output to a convolution layer 502. The convolution layer 502 generates a convolution output based on the concatenated output and sends the convolution output to a transformer block 503. The transformer block 503 generates an output feature which merges the two inputs.

In some examples, two inputs of the generative prior layer 102-1, the encoder features f₅ and the encoder feature f₆, are merged using the merge block shown in FIG. 5. Two inputs of the generative prior layer 102-3, the encoder features f₃ and the output feature generated by the generative prior layer 102-2, are merged using the merge block shown in FIG. 5. Two inputs of the generative prior layer 102-4, the encoder features f₂ and the output feature generated by the generative prior layer 102-3, are merged using the merge block shown in FIG. 5. Two inputs of the generative prior layer 102-5, the encoder features f₁ and the output feature generated by the generative prior layer 102-4, are merged using the merge block shown in FIG. 5.

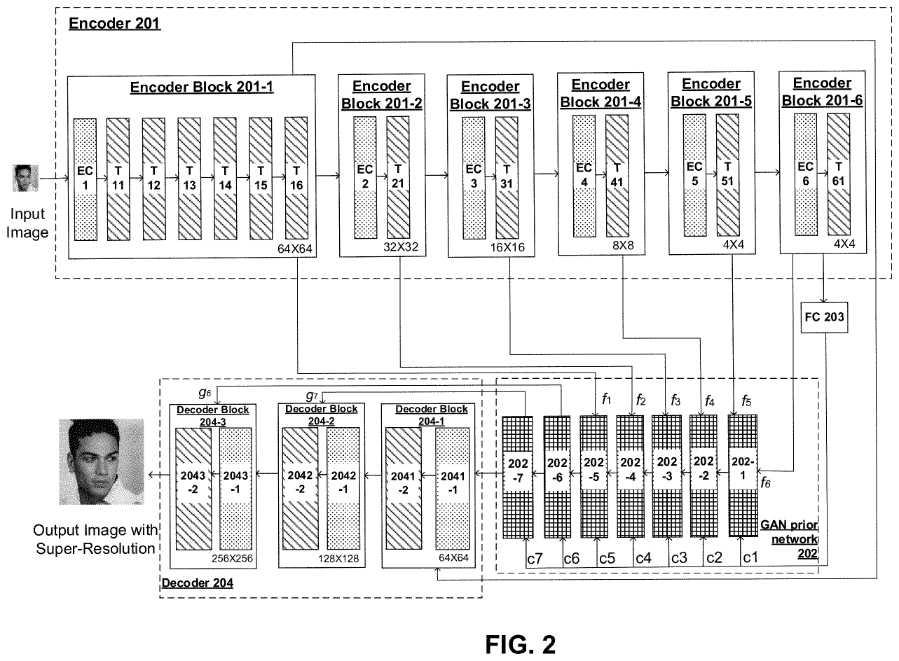

FIG. 2 is a block diagram illustrating a neural network system including an encoder with transformer blocks, a GAN prior network, and a decoder in accordance with one or more examples of the present disclosure. In addition to the encoder and the GAN prior network, the neural network system in FIG. 2 includes a decoder as well. The overall architecture of the neural network system in FIG. 2 includes the encoder and the decoder that separated with the trained weights of the GAN prior network. The GAN prior network is connected to the encoder and the decoder with skip connections. The encoder network is built using successive transformer blocks composed of self-attention layers and residual blocks. The decoder network includes convolution layers followed by pixel shuffle layers for features up-sampling. The output of each encoder block with a specific resolution is concatenated with the output of the corresponding block in the GAN prior network, then a convolution layer followed by a transformer block is applied to the results and the output is fed to the next block in the GAN prior network. In addition, the output of the last layer of the GAN prior network is used as an input to the decoder with the output of the initial encoder block in the encoder.

As shown in FIG. 2 the encoder 201 may be the same as the encoder 101 except that the encoder features f₁ is fed into the decoder 204 as well. The GAN prior network 202 may be the same as the GAN prior network 102 as shown in FIG. 1. The encoder 201 includes a plurality of encoder blocks 201-1, 201-2, . . . , 201-6. The GAN prior network 202 includes a plurality of generative prior layers 202-1, 202-2, . . . , 202-7. The generative prior layer 202-7 receives inputs including an output feature generated by the previous generative prior layer 202-6 and the latent vector c7, and then generates an output feature.

The decoder 204 includes a plurality of decoder blocks. The plurality of decoder blocks include the decoder blocks 204-1, 204-2, and 204-3 as shown in FIG. 2. Each decoder block include a convolution layer and a pixel shuffle layer that follows the convolution layer. For example, the decoder block 204-1 includes a convolution layer 2041-1 and a pixel shuffle layer 2041-2, the decoder block 204-2 includes a convolution layer 2042-1 and a pixel shuffle layer 2042-2, the decoder block 204-3 includes a convolution layer 2043-1 and a pixel shuffle layer 2043-2.

The convolution layer 2041-1 in the decoder block 204-1 receives inputs including the output feature from the generative prior layer 202-7 and the encoder feature f₁, and then generates an output feature. The pixel shuffle layer 2041-2 receives the output feature of the convolution layer 2041-1 and up-samples the output feature. For example, the pixel shuffle layer 2041-2 up-samples the output feature of the convolution layer 2041-1 to 64×64 and sends the up-sampled feature to the decoder block 204-2 that follows the decoder block 204-1.

The convolution layer 2042-1 in the decoder block 204-2 receives inputs including the up-sampled feature from the pixel shuffle layer 2041-2 and the output feature generated by the generative prior layer 202-7, and then generates an output feature. The pixel shuffle layer 2042-2 in the decoder block 204-2 receives the output feature from the convolution layer 2042-1 and up-samples the output feature. For example, the pixel shuffle layer 2042-2 up-samples the output feature of the convolution layer 2042-1 to 128×128 and sends the up-sampled feature to the decoder block 204-3 that follows the decoder block 204-2.

The convolution layer 2043-1 in the decoder block 204-3 receives inputs including the up-sampled feature from the pixel shuffle layer 2042-2 and the output feature generated by the generative prior layer 202-6, and then generates an output feature. The pixel shuffle layer 2043-2 in the decoder block 204-3 receives the output feature from the convolution layer 2043-1 and up-samples the output feature to generate the output image with super-resolution. For example, the pixel shuffle layer 2043-2 generates the output image with super-resolution by up-sampling the output feature of the convolution layer 2043-1 to 256×256.

The convolution layer in each decoder block shown in FIG. 2 uses the merge block illustrated in FIG. 5 to merge or combine inputs of the decoder block. For example, in the decoder block 204-1, its inputs including the encoder features f₁ and the output feature generated by the generative prior layer 202-7 are concatenated using the concatenating layer 501. That is, the encoder feature f₁ is the input 1 of the concatenating layer 501 and the output feature generated by the generative prior layer 202-7 is the input 2 of the concatenating layer 501. The concatenating layer 501 generates the concatenated output based on the input 1 and the input 2 and sends the concatenated output to the convolution layer 502. The convolution layer 502 generates the convolution output based on the concatenated output and sends the convolution output to the transformer block 503. The transformer block 503 generates the output feature which merges the two inputs.

In some examples, two inputs of the decoder block 204-2, the output feature generated by the GAN generative prior layer 202-7 and the up-sampled feature generated by the pixel shuffle layer 2041-2, are merged using the merge block shown in FIG. 5. Two inputs of the decoder block 204-3, the output feature generated by the GAN generative prior layer 202-6 and the up-sampled feature generated by the pixel shuffle layer 2042-2, are merged using the merge block shown in FIG. 5.

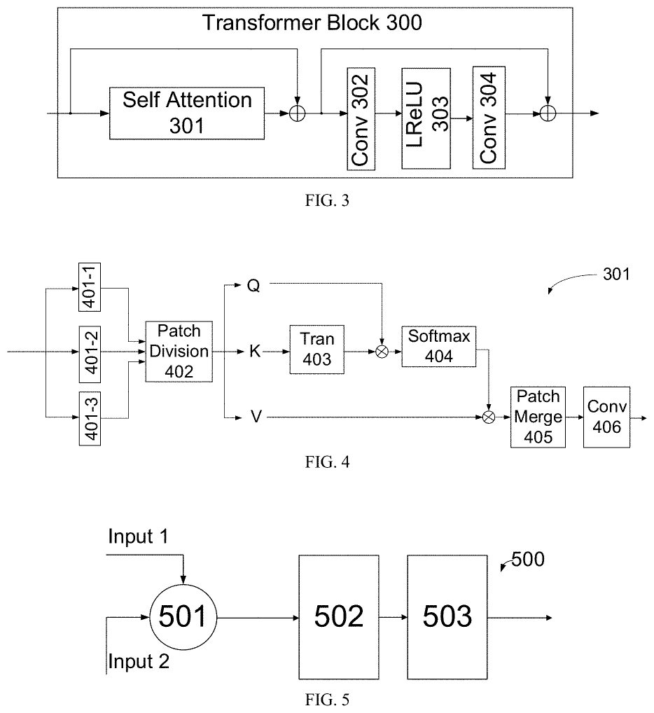

FIG. 3 is a block diagram illustrating a transformer block in the neural network system shown in FIG. 1, FIG. 2 or FIG. 5 in accordance with an example of the present disclosure. As shown in FIG. 3, the transformer block 300 includes a self-attention layer 301 with a skip connection, a convolution layer 302, a Leaky Rectified Linear Activation (LReLU) layer 303, and a convolution layer 304. The LReLU layer 303 is sandwiched between the convolution layer 302 and the convolution layer 304.

The output and input of the self-attention layer 301 are added to each other using a skip connection and the added result passed through a residual block to form the overall operations of the transformer block 301. For example, the added result is then sent to the convolution layer 302. The convolution layer 302 generates a first convolution output and sends the first convolution output to the LReLU layer 303. Further, the LReLU layer 303 generates an LReLU output and sends the LReLU output to the convolution layer 304, and the convolution layer 304 generates a second convolution output. The input of the convolution layer 302 and the second convolution output of the convolution layer 304 are added to each other using a skip connection to generate an output of the transformer block 300.

FIG. 4 is a block diagram illustrating a self-attention layer in the transformer block shown in FIG. 3 in accordance with an example of the present disclosure. The self-attention layer 301 may include a plurality of projection layers, e.g., separable depth-wise convolution layers, each of which respectively learns query, key, and value features. The query, key, and value features may be embeddings related to inputs of the self-attention layer. The outputs of the projection layers are divided into small patches through a patch division layer 402. K, Q and V may be respectively matrices of a set of key features, query features and value features. After division, the key features K is transposed using a transpose layer 403, the query features Q and the transpose of key features K are multiplied, and an attention map is obtained through a softmax layer 404. Moreover, the attention map is multiplied by the value features V and the output is merged using an inverse of the patch division operation through a patch merge layer 405 and a final convolution is applied using a convolution layer 406 to generate the output of the self-attention layer 301. The patch division layer 402 divides feature maps to patch block so as to reduce the computational cost without losing results performance.

In some examples, during the training of the neural network system, the weights of the generative prior network may be kept fixed. The neural network system is trained for an up-sampling factor of 4 from 64×64 to 256×256. The neural network system is trained for 200,000 iterations using mean square loss, perceptual loss and cross entropy loss.

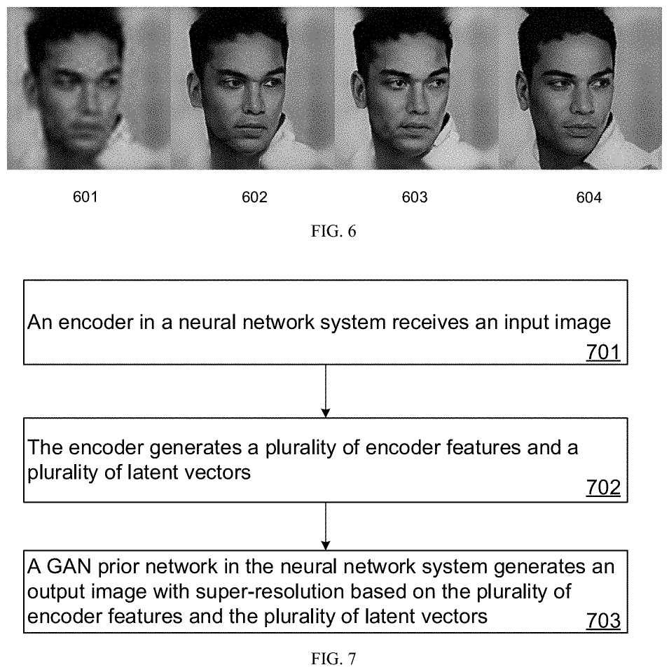

In some examples, the dataset used to train the neural network system is a synthetic dataset, composed of paired low-resolution and high-resolution image faces which simulate degradation found in real-world face images. FIG. 6 shows comparison among output images obtained respectively through bicubic up-sampling, PSFRGAN, GFP-GAN and the neural network system in accordance with an example of the present disclosure. As shown in FIG. 6, 601 shows an output image obtained using bicubic up-sampling, 602 shows an output image obtained using PSFRGAN, 603 shows an output image using GFP-GAN, and 604 shows an output image obtained using the neural network system in accordance with the present disclosure.

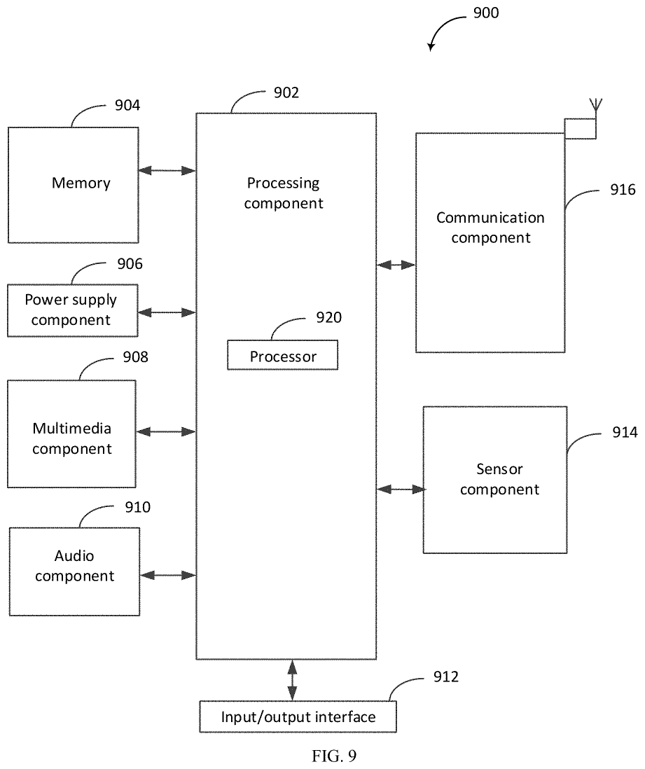

FIG. 9 is a block diagram illustrating an apparatus for restoring an image using a neural network system in accordance with an example of the present disclosure. The system 900 may be a terminal, such as a mobile phone, a tablet computer, a digital broadcast terminal, a tablet device, or a personal digital assistant.

As shown in FIG. 4, the system 900 may include one or more of the following components: a processing component 902, a memory 904, a power supply component 906, a multimedia component 908, an audio component 910, an input/output (I/O) interface 912, a sensor component 914, and a communication component 916.

The processing component 902 usually controls overall operations of the system 900, such as operations relating to display, a telephone call, data communication, a camera operation, and a recording operation. The processing component 902 may include one or more processors 920 for executing instructions to complete all or a part of steps of the above method. The processors 920 may include CPU, GPU, DSP, or other processors. Further, the processing component 902 may include one or more modules to facilitate interaction between the processing component 902 and other components. For example, the processing component 902 may include a multimedia module to facilitate the interaction between the multimedia component 908 and the processing component 902.

The memory 904 is configured to store different types of data to support operations of the system 900. Examples of such data include instructions, contact data, phonebook data, messages, pictures, videos, and so on for any application or method that operates on the system 900. The memory 904 may be implemented by any type of volatile or non-volatile storage devices or a combination thereof, and the memory 904 may be a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or a compact disk.

The power supply component 906 supplies power for different components of the system 900. The power supply component 906 may include a power supply management system, one or more power supplies, and other components associated with generating, managing, and distributing power for the system 900.

The multimedia component 908 includes a screen providing an output interface between the system 900 and a user. In some examples, the screen may include a Liquid Crystal Display (LCD) and a Touch Panel (TP). If the screen includes a touch panel, the screen may be implemented as a touch screen receiving an input signal from a user. The touch panel may include one or more touch sensors for sensing a touch, a slide and a gesture on the touch panel. The touch sensor may not only sense a boundary of a touching or sliding actions, but also detect duration and pressure related to the touching or sliding operation. In some examples, the multimedia component 908 may include a front camera and/or a rear camera. When the system 900 is in an operation mode, such as a shooting mode or a video mode, the front camera and/or the rear camera may receive external multimedia data.

The audio component 910 is configured to output and/or input an audio signal. For example, the audio component 910 includes a microphone (MIC). When the system 900 is in an operating mode, such as a call mode, a recording mode and a voice recognition mode, the microphone is configured to receive an external audio signal. The received audio signal may be further stored in the memory 904 or sent via the communication component 916. In some examples, the audio component 910 further includes a speaker for outputting an audio signal.

The I/O interface 912 provides an interface between the processing component 902 and a peripheral interface module. The above peripheral interface module may be a keyboard, a click wheel, a button, or the like. These buttons may include but not limited to, a home button, a volume button, a start button, and a lock button.

The sensor component 914 includes one or more sensors for providing a state assessment in different aspects for the system 900. For example, the sensor component 914 may detect an on/off state of the system 900 and relative locations of components. For example, the components are a display and a keypad of the system 900. The sensor component 914 may also detect a position change of the system 900 or a component of the system 900, presence or absence of a contact of a user on the system 900, an orientation or acceleration/deceleration of the system 900, and a temperature change of system 900. The sensor component 914 may include a proximity sensor configured to detect presence of a nearby object without any physical touch. The sensor component 914 may further include an optical sensor, such as a CMOS or CCD image sensor used in an imaging application. In some examples, the sensor component 914 may further include an acceleration sensor, a gyroscope sensor, a magnetic sensor, a pressure sensor, or a temperature sensor.

The communication component 916 is configured to facilitate wired or wireless communication between the system 900 and other devices. The system 900 may access a wireless network based on a communication standard, such as WiFi, 4G, or a combination thereof. In an example, the communication component 916 receives a broadcast signal or broadcast related information from an external broadcast management system via a broadcast channel. In an example, the communication component 916 may further include a Near Field Communication (NFC) module for promoting short-range communication. For example, the NFC module may be implemented based on Radio Frequency Identification (RFID) technology, infrared data association (IrDA) technology, Ultra-Wide Band (UWB) technology, Bluetooth (BT) technology and other technology.

In an example, the system 900 may be implemented by one or more of ASICs, Digital Signal Processors (DSPs), Digital Signal Processing Devices (DSPDs), Programmable Logic Devices (PLDs), FPGAs, controllers, microcontrollers, microprocessors, or other electronic elements to perform the above method.

A non-transitory computer readable storage medium may be, for example, a Hard Disk Drive (HDD), a Solid-State Drive (SSD), Flash memory, a Hybrid Drive or Solid-State Hybrid Drive (SSHD), a Read-Only Memory (ROM), a Compact Disc Read-Only Memory (CD-ROM), a magnetic tape, a floppy disk etc.

FIG. 7 is a flowchart illustrating a method for restoring an image using a neural network system implemented by one or more computers in accordance with an example of the present disclosure.

In step 701, an encoder in the neural network system receives an input image, as shown in FIG. 1 or FIG. 2.

In some examples, the encoder includes a plurality of encoder blocks, and each encoder block includes at least one transformer block and one convolutional layer. The encoder may be the encoder 101 shown in FIG. 1 or the encoder 201 shown in FIG. 2.

In step 702, the encoder generates a plurality of encoder features and a plurality of latent vectors. The plurality of encoder features may include the encoder features f₁, f₂, . . . , f₆ shown in FIG. 1 or FIG. 2. The plurality of latent vectors may include the latent vectors c1, c2, . . . , c7 shown in FIG. 1 or FIG. 2.

In step 703, a GAN prior network in the neural network system generates an output image with super-resolution based on the plurality of encoder features and the plurality of latent vectors. The GAN prior network includes a plurality of pre-trained generative prior layers, such as the generative prior layers 102-1, 102-2, . . . , and 102-7 shown in FIG. 1 or FIG. 2.

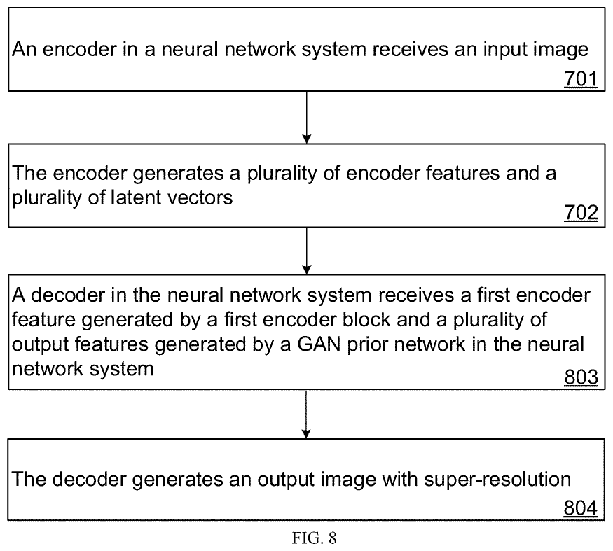

In some examples, a decoder is added following the GAN prior network to the neural network system. The decoder receives outputs of the GAN prior network and generate output images with super-resolution. FIG. 8 is a flowchart illustrating a method for restoring an image using a neural network system including an encoder, a GAN prior and a decoder implemented by one or more computers in accordance with an example of the present disclosure.

As shown in FIG. 8, after steps 701 and 702, step 803 is executed. In step 803, the decoder in the neural network receives a first encoder feature generated by a first encoder block and a plurality of output features generated by the GAN prior network in the neural network system.

In some examples, the decoder may be the decoder 204 and the first encoder block may be the encoder block 201-1 in FIG. 2.

In step 804, the decoder generates an output image with super-resolution.

In some examples, the first encoder block receives the input image, generates a first encoder feature, and sends the first encoder feature respectively to a pre-trained generative prior layer in the GAN prior network and a first decoder block in the decoder. The pre-trained generative prior layer may be the generative prior layer 202-5 shown in FIG. 2. The first decoder block may be the decoder block 204-1 shown in FIG. 2.

In some examples, each encoder block includes the at least one transformer block and one convolution layer followed by the at least one transformer block.

In some examples, the plurality of encoder blocks includes the first encoder block, a plurality of intermediate encoder blocks, and a last encoder block, the first encoder block includes multiple transformer blocks and a convolution layer followed by the multiple transformer blocks, the plurality of intermediate encoder blocks and the last encoder block respectively include a transformer block and a convolution layer followed by the transformer block. The plurality of intermediate encoder blocks may be the encoder layers 101-2, 101-3, 101-4, and 101-5 shown in FIG. 1, or the encoder blocks 201-2, 201-3, 201-4, and 201-5 shown in FIG. 2. The last encoder block may be the encoder layer 101-6 in FIG. 1 or the encoder block 201-6 shown in FIG. 2.

In some examples, resolutions of the plurality of encoder features decrease from the first encoder block to the last encoder block, as shown in FIG. 1 or FIG. 2. In FIG. 1, resolutions of the encoder layers 101-1, 101-2, . . . , 101-6 decrease from 64×64 to 4×4. In FIG. 2, resolutions of the encoder blocks 201-1, 201-2, . . . , 201-6 decrease from 64×64 to 4×4.

In some examples, a fully connected layer in the encoder receives a last encoder feature generated by the last encoder block and generates the plurality of latent vectors and respectively sends the plurality of latent vectors to the plurality of pre-trained generative prior layers. The fully connected layer may be the fully connected layer FC 103 in FIG. 1 or the fully connected layer FC 203 in FIG. 2.

In some examples, a first generative prior layer receives the last encoder feature from the last encoder block, a latent vector from the fully connected layer, and an encoder feature from an intermediate encoder block, where the plurality of pre-trained generative prior layers include a first generative prior layer, a plurality of intermediate generative prior layers, and a plurality of rear generative prior layers. The first generative prior layer may be the generative prior layer 102-1 in FIG. 1 or the generative prior layer 202-1 in FIG. 2. The plurality of intermediate generative prior layers may be the generative prior layers 102-2, . . . , and 202-5 in FIG. 1 or the generative prior layers 202-2, . . . , and 202-5 in FIG. 2. The plurality of rear generative prior layers may be the generative prior layers 102-6 and 102-7 in FIG. 1 or the generative prior layers 202-6 and 202-7 in FIG. 2. Each intermediate generative prior layer receives an output from a previous generative prior layer, an encoder feature from an encoder block, and a latent vector from the fully connected layer. Each rear generative prior layer receives an output from a previous generative prior layer and a latent vector from the fully connected layer.

In some examples, a first skip connection may generate an added result by adding an input to a self-attention layer and an output generated by the self-attention layer, and send the added result to a first convolution layer, where each transformer block includes the self-attention layer, the first convolution layer, a second convolution layer, a LReLU layer, the first skip connection, and a second skip connection, where the LReLU layer is sandwiched between the first convolution layer and the second convolution layer.

In some examples, the first convolution layer generates a first convolution output and sends the first convolution output to the LReLU layer, the LReLU layer generates an LReLU output and sends the LReLU output to the second convolution layer, the second convolution layer generates a second convolution output and sends the second convolution output to the second skip connection, and the second skip connection receives the second convolution output and the added result and generates an output of the transformer block.

In some examples, a plurality of projection layers respectively learn features of an input of the self attention layer and respectively generate a plurality of projection outputs. Each transformer block includes a self-attention layer including the plurality of projection layers, a patch division layer, a softmax layer, a patch merge layer, and a convolution layer. For example, the self-attention layer may be the self-attention layer 301 in FIGS. 3-4, the plurality of projection layers may be the projection layers 401-1, 401-2, and 401-3 in FIG. 4, the patch division layer may be the patch division layer 402, the softmax layer may be the softmax layer 404, the patch merge layer may be the patch merge layer 405, and the convolution layer may be the convolution layer 406 in FIG. 4.

Further, the patch division layer receives the plurality of projection outputs and divides the plurality of projection outputs into patches including query features, key features, and value features, the softmax layer generates an attention map based on the query features and the key features, the patch merge layer receives a multiplication of the value features and the attention map, and generates a merged output, and the convolution layer receives a multiplication of the value features and the attention map, and generates a merged output.

In some examples, weights of the plurality of generative prior layers, as shown in FIGS. 1-2, are pre-trained and fixed. In some examples, the weights may be updated, instead of fixed during the training of the neural network system.

In some examples, the output image with super-resolution of the neural network system is reconstructed from the input image and has higher resolution than the input image. For example, the output image at least doubles original resolution of the input image.

In some examples, there is provided a non-transitory computer readable storage medium 904, having instructions stored therein. When the instructions are executed by one or more processors 920, the instructions cause the processor to perform methods as illustrated in FIGS. 7-8 and described above.

In the present disclosure, the neural network system incorporates long range dependencies, transformer blocks, and the generative prior found in a well-trained GAN network to achieve better results for face super-resolution.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

The examples were chosen and described to explain the principles of the disclosure, and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A neural network system implemented by one or more computers for restoring an image, comprising:
an encoder comprising a plurality of encoder blocks, wherein each encoder block comprises at least one transformer block and one convolution layer, wherein the encoder receives an input image and generates a plurality of encoder features and a plurality of latent vectors; and
a generative adversarial network (GAN) prior network comprising a plurality of pre-trained generative prior layers, wherein the GAN prior network receives the plurality of encoder features and the plurality of latent vectors from the encoder and generates an output image with super-resolution.

2. The neural network system of claim 1, further comprising:
a decoder comprising a plurality of decoder blocks, wherein each decoder block comprises a convolution layer and a pixel shuffle layer, wherein the decoder receives a first encoder feature generated by a first encoder block and a plurality of output features generated by the GAN prior network, and generates the output image wither super-resolution.

3. The neural network system of claim 2, wherein each encoder block comprises the at least one transformer block and one convolution layer followed by the at least one transformer block,
wherein the plurality of encoder blocks comprises the first encoder block, a plurality of intermediate encoder blocks, and a last encoder block, the first encoder block comprises multiple transformer blocks and a convolution layer followed by the multiple transformer blocks, the plurality of intermediate encoder blocks and the last encoder block respectively comprise a transformer block and a convolution layer followed by the transformer block, and
wherein the first encoder block receives the input image, generates a first encoder feature, and sends the first encoder feature respectively to a pre-trained generative prior layer in the GAN prior network and a first decoder block in the decoder.

4. The neural network system of claim 3, wherein resolutions of the plurality of encoder features decrease from the first encoder block to the last encoder block.

5. The neural network system of claim 3, wherein the encoder comprises a fully connected layer that receives a last encoder feature generated by the last encoder block and generates the plurality of latent vectors, and
wherein the fully connected layer respectively sends the plurality of latent vectors to the plurality of pre-trained generative prior layers.

6. The neural network system of claim 5, wherein the plurality of pre-trained generative prior layers comprise a first generative prior layer, a plurality of intermediate generative prior layers, and a plurality of rear generative prior layers,
wherein the first generative prior layer receives the last encoder feature from the last encoder block, a latent vector from the fully connected layer, and an encoder feature from an intermediate encoder block,
wherein each intermediate generative prior layer receives an output from a previous generative prior layer, an encoder feature from an encoder block, and a latent vector from the fully connected layer, and
wherein each rear generative prior layer receives an output from a previous generative prior layer and a latent vector from the fully connected layer.

7. The neural network system of claim 1, wherein each transformer block comprises a self-attention layer, a first convolution layer, a second convolution layer, a Leaky Rectified Linear Activation (LReLU) layer, a first skip connection, and a second skip connection,
wherein the LReLU layer is sandwiched between the first convolution layer and the second convolution layer,
wherein the first skip connection generates an added result by adding an input to the self-attention layer and an output generated by the self-attention layer, and sends the added result to the first convolution layer,
wherein the first convolution layer generates a first convolution output and sends the first convolution output to the LReLU layer,
wherein the LReLU layer generates an LReLU output and sends the LReLU output to the second convolution layer,
wherein the second convolution layer generates a second convolution output and sends the second convolution output to the second skip connection, and
wherein the second skip connection receives the second convolution output and the added result and generates an output of the transformer block.

8. The neural network system of claim 1, wherein each transformer block comprises a self attention layer comprising a plurality of projection layers, a patch division layer, a softmax layer, a patch merge layer, and a convolution layer,
wherein the plurality of projection layers respectively learn features of an input of the self attention layer and respectively generate a plurality of projection outputs,
wherein the patch division layer receives the plurality of projection outputs and divides the plurality of projection outputs into patches comprising query features, key features, and value features,
wherein the softmax layer generates an attention map based on the query features and the key features,
wherein the patch merge layer receives a multiplication of the value features and the attention map, and generates a merged output, and
wherein the convolution layer receives the merged output and generates an output of the self attention layer.

9. The neural network system of claim 1, wherein weights of the plurality of pre-trained generative prior layers are fixed, and
wherein the output image with super-resolution is reconstructed from the input image and at least doubles original resolution of the input image.

10. A method for restoring an image using a neural network system implemented by one or more computers, comprising:
receiving, by an encoder in the neural network system, an input image, wherein the encoder comprises a plurality of encoder blocks, wherein each encoder block comprises at least one transformer block and one convolutional layer;
generating, by the encoder, a plurality of encoder features and a plurality of latent vectors; and
generating, by a generative adversarial network (GAN) prior network in the neural network system, an output image with super-resolution based on the plurality of encoder features and the plurality of latent vectors, wherein the GAN prior network comprises a plurality of pre-trained generative prior layers.

11. The method of claim 10, further comprising:
receiving, by a decoder in the neural network system, a first encoder feature generated by a first encoder block and a plurality of output features generated by the GAN prior network, wherein the decoder comprises a plurality of decoder blocks, wherein each decoder block comprises a convolution layer and a pixel shuffle layer; and
generating, by the decoder, the output image with super-resolution.

12. The method of claim 11, further comprising:
receiving, by the first encoder block, the input image;
generating, by the first encoder block, a first encoder feature; and
sending, by the first encoder block, the first encoder feature respectively to a pre-trained generative prior layer in the GAN prior network and a first decoder block in the decoder,
wherein each encoder block comprises the at least one transformer block and one convolution layer followed by the at least one transformer block, and
wherein the plurality of encoder blocks comprises the first encoder block, a plurality of intermediate encoder blocks, and a last encoder block, the first encoder block comprises multiple transformer blocks and a convolution layer followed by the multiple transformer blocks, the plurality of intermediate encoder blocks and the last encoder block respectively comprise a transformer block and a convolution layer followed by the transformer block.

13. The method of claim 12, wherein resolutions of the plurality of encoder features decrease from the first encoder block to the last encoder block.

14. The method of claim 12, further comprising:
receiving, by a fully connected layer in the encoder, a last encoder feature generated by the last encoder block and generating the plurality of latent vectors; and
respectively sending, by the fully connected layer, the plurality of latent vectors to the plurality of pre-trained generative prior layers.

15. The method of claim 14, further comprising:
receiving, by a first generative prior layer, the last encoder feature from the last encoder block, a latent vector from the fully connected layer, and an encoder feature from an intermediate encoder block, wherein the plurality of pre-trained generative prior layers comprise a first generative prior layer, a plurality of intermediate generative prior layers, and a plurality of rear generative prior layers;
receiving, by each intermediate generative prior layer, an output from a previous generative prior layer, an encoder feature from an encoder block, and a latent vector from the fully connected layer; and
receiving, by each rear generative prior layer, an output from a previous generative prior layer and a latent vector from the fully connected layer.

16. The method of claim 10, further comprising:
generating, by a first skip connection, an added result by adding an input to a self-attention layer and an output generated by the self-attention layer, and sending the added result to a first convolution layer, wherein each transformer block comprises the self-attention layer, the first convolution layer, a second convolution layer, a Leaky Rectified Linear Activation (LReLU) layer, the first skip connection, and a second skip connection, wherein the LReLU layer is sandwiched between the first convolution layer and the second convolution layer;
generating, by the first convolution layer, a first convolution output and sending the first convolution output to the LReLU layer;
generating, by the LReLU layer, an LReLU output and sending the LReLU output to the second convolution layer;
generating, by the second convolution layer, a second convolution output and sending the second convolution output to the second skip connection; and
receiving, by the second skip connection, the second convolution output and the added result and generating an output of the transformer block.

17. The method of claim 10, further comprising:
respectively learning, by a plurality of projection layers, features of an input of the self attention layer and respectively generating a plurality of projection outputs, wherein each transformer block comprises a self attention layer comprising the plurality of projection layers, a patch division layer, a softmax layer, a patch merge layer, and a convolution layer;
receiving, by the patch division layer, the plurality of projection outputs and dividing the plurality of projection outputs into patches comprising query features, key features, and value features;
generating, by the softmax layer, an attention map based on the query features and the key features;
receiving, by the patch merge layer, a multiplication of the value features and the attention map, and generating a merged output; and
receiving, by the convolution layer, a multiplication of the value features and the attention map, and generating a merged output.

18. The method of claim 10, wherein weights of the plurality of pre-trained generative prior layers are fixed, and
wherein the output image with super-resolution is reconstructed from the input image and at least doubles original resolution of the input image.

19. A non-transitory computer-readable storage medium for restoring an image storing computer-executable instructions that, when executed by one or more computer processors, causing the one or more computer processors to perform acts comprising:
receiving, by an encoder in a neural network system, an input image, wherein the encoder comprises a plurality of encoder blocks, wherein each encoder block comprises at least one transformer block and one convolutional layer;
generating, by the encoder, a plurality of encoder features and a plurality of latent vectors; and
generating, by a generative adversarial network (GAN) prior network in the neural network system, an output image with super-resolution based on the plurality of encoder features and the plurality of latent vectors, wherein the GAN prior network comprises a plurality of pre-trained generative prior layers.

20. The non-transitory computer-readable storage medium of claim 19, the one or more computer processors are caused to perform acts further comprising:
receiving, by a decoder in the neural network system, a first encoder feature generated by a first encoder block and a plurality of output features generated by the GAN prior network, wherein the decoder comprises a plurality of decoder blocks, wherein each decoder block comprises a convolution layer and a pixel shuffle layer; and
generating, by the decoder, the output image with super-resolution.
